(19) United States
(12) Patent Application Publication
(10) Pub. No.: US 2010/0319003 A1
(43) Pub. Date: Dec. 16, 2010

(54) MOBILE COMMUNICATIONS DEVICE PROGRAMMED WITH MESSAGE LOGGING CAPABILITY

(75) Inventor: Ofer Halevi, Middlesex (GB)

Correspondence Address: Saul Ewing LLP (Philadelphia);Attn: Patent Docket Clerk, Penn National Insurance Plaza, 2 North Second St., 7th Floor, Harrisburg, PA, 17101, US

(73) Assignee: Symbian Software Limited, London (GB)

(21) Appl. No.: 12/376,870

(22) PCT Filed: Aug. 8, 2007
(86) PCT No.: PCT/GB07/02995

§ 371 Date: Aug. 27, 2010

(30) Foreign Application Priority Data
Aug. 9, 2006 (GB) 0615840,6

(51) Int. Cl. G06F 9/46

(52) U.S. Cl. 719/313; 719/328

(57) ABSTRACT

This invention relates to a mobile communications device programmed to provide logging of messaging activity. In one implementation, the programme provides near real-time notification and control of mobile phone messaging. The notification is to a back-end logging system.

### FIELD OF THE INVENTION

This invention relates to a mobile communications device programmed to provide logging of messaging activity. In one implementation, the programme provides near real-time notification and control of mobile phone messaging. The notification is to a back-end logging system.

Current mobile telephones typically include a log of received SMS and MMS messages, generally referred to as an Inbox. Some mobile telephones provide enhanced logging functionality whereby sent items are also retained, as are messages that could not be sent, for example due to a lack of network availability.

Email systems provided on mobile communications devices or desktop computers tend to have more sophisticated arrangements for logging messages, including the ability to define folders into which messages can be moved.

For both mobile devices and desktop computers, storage capacity can be a limitation on the capability of any message log to retain and organise sent and received messages. This generally manifests itself in two ways: by slowing down the operation of a messaging application when a large number of messages is being stored; and/or by causing an error message to be generated when a storage limit is reached, requiring a user to manually delete those items that are no longer needed.

Further control of message logging arrangements is desirable in order to reduce the effort required by a user to manage his messages and in order to avoid the inconvenience of slowing down or preventing further use of a messaging application when the stored messages reach a certain size.

### SUMMARY

In accordance with a first aspect of the present invention there is provided a mobile communications device programmed with: (a) a messaging events monitoring agent, registered with a messaging API provided by an operating system of the device so as to receive notifications of any messaging related events; (b) a message handling agent for processing messaging events received from the messaging events monitoring agent and arranged to communicate with the messaging API based on configured policy, the message handling agent being arranged to store logs of device messaging activity; (c) a communications agent that uses a communications API of the operating system to communicate the logs stored by the message handling agent to a back-end logging system using available communications means provided by the communications API.

In accordance with a second aspect of the invention there is provided a method of enabling a mobile communications device to log messages, comprising the steps of: (a) a messaging events monitoring agent registering with a messaging API provided by an operating system of the mobile device in order to receive notifications of any message related events; (b) a message handling agent processing messaging events received from the message events monitoring agent and arranged to communicate with the messaging API based on configured policy, the step of processing including storing logs of device message activity; (c) a communications agent using a communications API of the operating system to communicate the logs stored by the message handling agent to a back-end logging system using available communications means provided by the communications API.

In accordance with a third aspect of the invention there is provided a system for enabling mobile device messages to be logged, the system comprising multiple mobile communications devices as defined above and a back-end logging system arranged to receive logs from the mobile devices.

Preferred features of the invention are set out in the dependent claims.

### DESCRIPTION OF DRAWINGS

The invention will now be described by way of example with reference to the accompanying drawing, in which:

FIG. 1 shows a message handling arrangement including a back-end logging system.

### DETAILED DESCRIPTION

Embodiments of the present invention enable a mobile communications device to intelligently control the handling of messages and messaging events, by reporting messaging events to a logging system and implementing a messaging policy using that logging system. A message handling agent receives input from a messaging events monitoring agent, and the message handling agent communicates with a messaging API of the device to enforce a policy for handling messages and messaging events.

In the preferred embodiment, a method is provided by which 1) messaging events on mobile devices (e.g. sending and receiving SMS, MMS, or e-mail messages) can be reported to a back-end logging system, and 2) messaging activities on the device can be controlled based on a dynamic policy (message barring for outgoing and incoming messages, cost control, automatic deletion, automatic response, etc.).

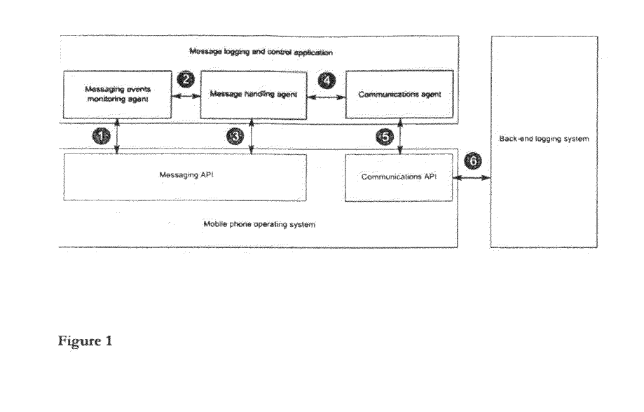

The following series of steps explains how an embodiment of the invention can be used on a mobile telephone. The steps are illustrated in FIG. 1.
1) The “Messaging events monitoring agent” registers with the mobile phone operating system's Messaging API in order to receive notifications of any messaging related events:
   a. Outgoing message (SMS, MMS, e-mail);
   b. Incoming message (SMS, MMS, e-mail);
   c. Message status change—draft, sent, inbox, read flag, etc.
2) The “Messaging events monitoring agent” notifies the “Message handling agent” of messaging events received from the Messaging API.
3) The “Message handling agent” processes messaging events received from the “Messaging events monitoring agent” and responds to the Messaging API based on configured policy. Message handling policy may cover the following functions:
   a. Log outgoing message information and content;
   b. Log incoming message information and content;
   c. Automatically respond to incoming messages;
   d. Automatically delete incoming messages (immediately, after a given amount of time, once read, etc.);
   e. Automatically delete outgoing messages;
   f. Determine response based on dynamic properties including message content or properties, date, time, location (GSM network location and/or GPS), message origin or destination, associated contact information (in business contacts group or personal contacts group, etc.), diary information, selected profile, etc.;
   g. Capture additional state information such as network information (network name, GSM country, area and cell, signal level), device status (memory consumption, battery level, selected profile);
   h. Determine schedule for communicating log information to the “Back-end logging system” (after each messaging event, every specific amount of time, at specific times, once a specific amount of log information has been captured, message origin or destination, message content, message size, etc.).
4) “Message handling agent” communicates message logging information to the “Communications agent” based on scheduling policy; Information may be augmented with additional device information such as device identification (IMEI, IMSI), network information (network type and identification, country, area and cell information). The “Communications agent” notifies the “Message handling agent” of any message handling policy modification requests received from the “Back-end logging system”.
5) The “Communications agent” uses the mobile phone operating system's communications API to communicate with the “Back-end logging system” using available communications means provided by the communications API:
   a. A TCP/IP communication protocol (HTTP, FTP, SMTP, etc.)
   b. A GSM communication channel such as SMS, MMS.
6) The “Back-end logging system” may control the “Message handling agent” policy by communicating policy modifications using available communications means via the “Communications agent”.

The back-end logging system is preferably provided remotely from the device. In this arrangement, the relatively small quantity of storage memory available on current mobile phones need not be impacted by the logged messaging data. Large quantities of storage memory can be provided on remote servers without reducing the available storage on the mobile device. However, it is possible to implement an embodiment of the invention in which the back-end logging system is provided in the device itself. Such an arrangement would have certain advantages: for example, the time taken for data or instructions to be transferred between the logging system and the communications agent could be much shorter.

The communication between the communications agent on the mobile telephone and the logging system preferably involves delivering all recent events logged by the message handling agent to the logging system, and then deleting them from the message handling agent's local log. Once received at the back-end logging system, the recent events are compared with those already stored at the logging system, and updates are made accordingly.

The message handling policy defines the manner in which messages and messaging events are dealt with in the mobile device. It includes a series of rules which specify what should be done in particular circumstances or in response to a particular event. It can be used to control the content of the logging system, the deletion of certain messages, the movement of messages between folders, or any other activity relating to messaging on the device.

In the case where the back-end logging system is used to direct the message handling policy, it could feed back to either the messaging API or the communications agent. It could formulate and modify policy based on criteria such as the amount of storage space available for storing new messaging information, the communication networks available to the device or the battery level. It could also be capable of receiving input from a user in order that the user can influence policy decisions. Alternatively it may be preferred that the user cannot access the back-end logging system, since making it directly accessible from the application level could represent a security risk—malicious or malfunctioning applications could potentially obtain or modify information from the logging system, thereby compromising the user's personal messaging information.

In the preferred embodiment the message handling policy is enforced at the message handling agent, which receives directions from the communications agent. The message handling agent communicates directly with the Messaging API in order to implement aspects of the message handling policy; however, the message handling agent could alternatively communicate with the API indirectly, via the messaging events monitoring agent or another element. In one embodiment, a user of the device can define at least some aspects of the message handling policy by means of interaction with the message handling agent, either directly or indirectly.

The scheduling policy defines the manner in which data is passed to the back-end logging system. It can define the type of information provided to the back-end logging system, as well as the timing of transmissions to the logging system. The scheduling policy could be determined on a dynamic basis according to the usage of the device's messaging applications. For example, when the device is being used frequently for messaging—perhaps during a weekday while the user is away from his office—the communication to the back-end logging system could be performed relatively frequently, whereas during a period of low usage—perhaps during a weekday while the user is at his office desk and primarily using his office phone and computer to send and receive communications—the communication to the back-end logging system could be performed infrequently. This variation in scheduling policy could be achieved by the use of a usage monitoring or prediction agent arranged to determine the current or likely messaging behaviour of the device.

In the preferred embodiment, all of the agents described above—the messaging events monitoring agent, the message handling agent, the communications agent, and the usage monitoring agent—are provided as a single message logging and control application. Alternatively, the logging and control aspects could be provided by separate applications, or some or all of the functionality could be provided within the operating system.

A simple example of the operation of the message logging and control arrangement of the present invention will now be given.

A mobile telephone receives an incoming email message. The messaging events monitoring agent receives a notification from the Messaging API, indicating the receipt of an email, the address from which the email was received, the timestamp of the email, and its size in bytes. The message handling agent is informed of this message handling event by the messaging events monitoring agent. The message handling agent stores the incoming email as an event in a store of recent events: an entry is made in the store to include the nature of the event (receipt of an email), the timestamp of the email, the address from which it was received, and its size.

At this time, the message handling agent does not communicate back to the Messaging API since no action needs to be taken by the Messaging API in response to this event.

Shortly after receiving the new email, the user of the device opens the email to read it. The Messaging API notifies the messaging events monitoring agent that the email has now been opened, and this information is passed to the message handling agent. The message handling agent then records the time and date of the opening of the message against the email's entry in the store of events.

The mobile telephone in the example is currently configured to delete the body of all read emails 2 days after they are opened. This configuration has been selected by the user while he is away from the office in meetings, to ensure that his inbox does not become too full. This policy setting is implemented by means of the back-end logging system, with which the user can communicate by password access to change his message handling policy.

In accordance with this policy setting, the message handling agent begins a timer when the new email is opened by the user. Two days later, the message handling agent triggers the Messaging API to delete the body of the email, and the email is consequently deleted. The time and date of this event are logged by the message handling agent against the entry for the email.

The scheduling policy in force for the mobile telephone is fixed, and requires that all messaging events stored by the message handling agent are transmitted to the back-end logging system at midnight every day. Thus, at midnight on the day the user received and opened his new email, the communications agent retrieves the new entry in the message handling agent's store and sends it over a GSM network to a remote back-end logging system. Similarly, at midnight on the day the email's body is deleted, the communications agent transmits the updated entry to the remote back-end logging system.

It can be seen from the above description that the present invention provides a flexible and powerful technique for controlling and logging messaging activity on a mobile device. It will be understood by the skilled person that alternative implementations are possible, and that various modifications of the methods and implementations described above may be made within the scope of the invention, as defined by the appended claims.

1. A mobile communications device programmed with:
(a) a messaging events monitoring agent, registered with a messaging API provided by an operating system of the device so as to receive notifications of any messaging related events;
(b) a message handling agent for processing messaging events received from the messaging events monitoring agent and arranged to communicate with the messaging API based on a configured message handling policy, the message handling agent being arranged to store logs of device messaging activity;
(c) a communications agent that uses a communications API of the operating system to communicate the logs stored by the message handling agent to a back-end logging system using available communications means provided by the communications API.

2. The device of claim 1 in which the messaging related events include one or more of:
a) Generating or transmitting an outgoing message;
b) Receiving an incoming message;
c) Message status change, where the statues include draft, sent, inbox, read flag.

3. The device of claim 1 in which the configured policy includes one or more of the following:
a) Log outgoing message information and content;
b) Log incoming message information and content;
c) Automatically respond to incoming messages;
d) Automatically delete incoming messages;
e) Automatically delete outgoing messages;
f) Determine response based on dynamic properties including message content or properties, date, time, location, message origin or destination, associated contact information, diary information, or selected profile;
g) Capture additional state information such as network information or device status;
h) Determine schedule for communicating log information to the back-end logging system.

4. The device of claim 1 in which the message handling agent communicates message logging information to the communications agent based on a scheduling policy.

5. The device of claim 4 in which the message logging information may be augmented with additional device information such as device identification or network information.

6. The device of claim 1 in which the communications agent notifies the message handling agent of any message handling policy modification requests received from the back-end logging system.

7. The device of claim 1 in which the available communications means provided by the communications API includes one of: a) A TCP/IP communication protocol (HTTP, FTP, SMTP, etc.) b) A GSM communication channel such as SMS, MMS.

8. The device of claim 1, arranged such that the back-end logging system can dynamically control the message handling policy by communicating policy modifications to the message handling agent using available communications means via the communications agent.

9. A method of enabling a mobile communications device to log messages, comprising the steps of:
(a) a messaging events monitoring agent registering with a messaging API provided by an operating system of the mobile device in order to receive notifications of any message related events;
(b) a message handling agent processing messaging events received from the message events monitoring agent and arranged to communicate with the messaging API based on a configured message handling policy, the step of processing including storing logs of device message activity;
(c) a communications agent using a communications API of the operating system to communicate the logs stored by the message handling agent to a back-end logging system using available communications means provided by the communications API.

10. A system for enabling mobile device messages to be logged, the system comprising multiple mobile communications devices as claimed in claim 1 and a back-end logging system arranged to receive logs from the mobile devices.

11. The system of claim 10 in which the back-end logging system is also arranged to log telephone calls received from mobile telephone and from landline calls.
